(19) United States
(12) Patent Application Publication
(10) Pub. No.: US 2015/0266266 A1
(43) Pub. Date: Sep. 24, 2015

(54) COMPOSITE FABRICS AND METHODS OF MAKING SAME

(71) Applicant: Lincoln Fabrics, Inc., St. Catharine's (CA)

(72) Inventors: Tulin Oktem, St. Catherines (CA); Andre Beth, Toronto (CA); Steve Dye, Geneva, AL (US)

(21) Appl. No.: 14/213,534

(22) Filed: Mar. 14, 2014

Related U.S. Application Data
(60) Provisional application No. 61/794,654, filed on Mar. 15, 2013.

(51) Int. Cl. B32B 5/26; D03D 1/00; D03D 11/00; B32B 5/02

(52) U.S. Cl. CPC B32B 5/26; B32B 5/024; B32B 5/022; D03D 1/0052; D03D 11/00; B32B 2437/00; B32B 2305/188; B32B 2260/046; D03D 2700/0118

(57) ABSTRACT

A multi-layer composite fabric comprises a first woven layer having a plurality of warp yarns and plurality of weft yarns, a second woven layer having a plurality of warp yarns and plurality of weft yarns, and a third non-crimp layer disposed between the first woven layer and the second woven layer. The first woven layer can be joined to one or more of the following: the second woven layer and the third non-crimp layer.

### CROSS-REFERENCE TO RELATED APPLICATION

This application claims the benefit of priority to U.S. provisional patent application Ser. No. 61/794,654 filed Mar. 15, 2013, the disclosures of which is incorporated herein by reference.

### FIELD OF THE DISCLOSURE

The present disclosure relates to the field of composite fabrics and methods of making composite fabrics.

### BACKGROUND OF THE DISCLOSURE

Designers of bullet-resistant vests (“ballistic vests”) have long struggled with the conflicting priorities of increased bullet resistance and increased comfort and mobility of the wearer. Effective ballistic vests must be manufactured from a material that meets a minimum performance threshold for resistance to ballistic projectiles. Through the years, woven goods have not only provided the necessary ballistic protection, but also have encouraged users to wear the vests due to the relative comfort from the flexibility and reasonable weight. Recent changes in ballistic resistance standards, for example, National Institute of Justice (“NU”) Standard 0101.06, titled “Ballistic Resistance of Body Armor,” have created significant new limitations on vest performance. In particular, toughened standards on the “backface signature”—deformation of the wearer-side of a vest caused by the impact of a projectile—have caused vest designers to limit the quantity of woven fabrics formerly used in these garments. Stiffer materials, such as laminated, unidirectional, and/or non-woven materials have displaced up to 50% of the woven goods used in current vests. This changed has drastically reduced the comfort of the vests.

Para-aramid materials, such as Twaron® and Kevlar®, are currently the leading fibers due to their excellent mechanical performance and acceptable stability. Kevlar is spun into fibers, and weaving the fibers (or bundles of Kevlar fibers—“yarns”) causes an impacting bullet to stretch the fibers in order to penetrate. The bullet-stopping power is primarily due to the large amount of energy required to stretch a molecule of Kevlar. Therefore, a bullet's kinetic energy is absorbed in stretching (and breaking) the Kevlar fibers upon impact. Energy is also radially dissipated (radiating through the fabric layer from the point of impact) through the weave structure.

Composite materials using aramid fibers combined with vibration dampening substances are known in the art. U.S. Patent Application Publication 2009/0075026, to Vito et al., (the “'026 Application”) discloses a composite material made by using an aramid fiber weave disposed between two elastomeric layers. Such technologies have been used successfully to reduce the effects of a non-ballistic impact of an object by absorbing mechanical vibrational energy in the first (outermost) elastomeric material, and redirecting vibrational energy and providing stiffness in the fibrous material layer. In ballistic resistant applications, however, an outer elastomer layer will have little effect in absorbing the kinetic energy of a bullet. The '026 Application teaches the use of one or more generally rigid plates of rigid materials to distribute the impact force over an increased amount of the composite material. Such a composite with rigid plates is taught as useful in using the material in, for example, bulletproof vests. As such, designs of ballistic vests with composite materials include the use of stiffer, rigid materials in response to the backface signature standards of NIJ 0101.06. However, the usability and comfort of the wearer is affected by such composites due to the stiffness of the fibrous material layer and generally rigid plates.

Textiles used in ballistic resistant materials may be configured in weave patterns which have ballistic resistant qualities. Specifically, the weave pattern should be resistant to penetration of a ballistic projectile by causing the energy to be transformed into stretching and/or breaking fibers. This is best performed when the weave is capable of maintaining its configuration without, for example, spreading yarns apart to allow passage of the projectile without sufficient energy transferred into stretching fibers (or conversely being forced together by a passing projectile). A primary technique previously used to maintain the configuration of a weave is to create a textile with a tight weave (i.e., having low air permeability). However, such a tight weave typically increases the stiffness of the fabric—negatively impacting usability and comfort.

Ultra-high-molecular-weight polyethylene (UHMWPE) is another material that exhibits ballistic resistant qualities. Notably, it has been found that UHMWPE can exhibit greater ballistic properties than traditional para-aramid fiber. However, to take advantage of the superior ballistic properties the UHMWPE, fabrics made of UHMWPE are laminated in sheets that are 1-2 layers in thickness. Laminating UHMWPE increases the weight, thickness, and stiffness of the fabric, which negatively impacts usability and comfort.

Composite fabric materials also have applications outside of the ballistics field, including, but not limited to, aircraft, marine, automobile, manufacturing, and construction. These composite fabrics often include a plurality of laminated panels that are pressed together to form the composite. These composite fabric panels are relatively time-intensive to manufacture, thick, and heavy.

Accordingly, there is a need for an improved composite fabric which reduces weight, increases strength, and/or increases workability.

### DESCRIPTION OF THE DRAWINGS

For a fuller understanding of the nature and objects of the invention, reference should be made to the following detailed description taken in conjunction with the accompanying drawings, in which:

FIG. 1 depicts a multi-layer composite fabric according to an embodiment of the present disclosure, the layers of the fabric not being shown woven together for illustrative purposes;

FIG. 2 depicts a multi-layer composite fabric according to an embodiment of the present disclosure;

FIG. 3 depicts a multi-layer composite fabric according to another embodiment of the present disclosure;

FIG. 4 is a schematic of a multi-layer composite fabric having four layers of material;

FIG. 5 is a schematic of a multi-layer composite fabric having a resin or laminate;

FIG. 6 depicts a method according to an embodiment of the disclosure; and

FIG. 7 depicts a method according to another embodiment of the disclosure.

### BRIEF SUMMARY OF THE DISCLOSURE

The present disclosure may be embodied as a multi-layer composite fabric including a first woven layer having a plurality of warp yarns and plurality of weft yarns, a second woven layer having a plurality of warp yarns and plurality of weft yarns, and a third non-crimp layer disposed between the first woven layer and the second woven layer. The first woven layer can be woven to one or more of the following: the second woven layer and at least a portion of the third non-crimp layer.

The present disclosure may also be embodied as a multi-layer composite fabric including a first woven layer having a plurality of warp yarns and plurality of weft yarns, a second woven layer having a plurality of warp yarns and plurality of weft yarns, and a third non-crimp layer disposed between the first woven layer and the second woven layer. The first woven layer and the second woven layer are joined to each other by picking one or more warp yarns of the second woven layer using a plurality of weft yarns from the first woven layer and/or picking one or more warp yarns of the first woven layer using a plurality of weft yarns from the second woven layer to form the composite fabric. The multi-layer composite fabric may or may not include a resin or laminate.

The disclosure can be embodied as a method A method of making a multi-layer composite fabric, including weaving a first woven layer having a plurality of warp yarns and plurality of weft yarns to one or more of the following: a second woven layer having a plurality of warp yarns and plurality of weft yarns and a third non-crimp layer. The third non-crimp layer can be disposed between the first woven layer and the second woven layer.

In another embodiment, the present disclosure is embodied as a method of making a multi-layer composite fabric including weaving a first, woven layer having a plurality of warp yarns and plurality of weft yarns to a second, woven layer having a plurality of warp yarns and plurality of weft yarns, and disposing a third, non-crimp layer between the first woven layer and the second woven layer. The first woven layer and the second woven layer are joined to each other by picking one or more warp yarns of the second woven layer using a plurality of weft yarns from the first woven layer and/or picking one or more warp yarns of the first woven layer using a plurality of weft yarns from the second woven layer to form the composite fabric. The multi-layer composite fabric may or may not include a resin.

### Detailed Description of the Disclosure

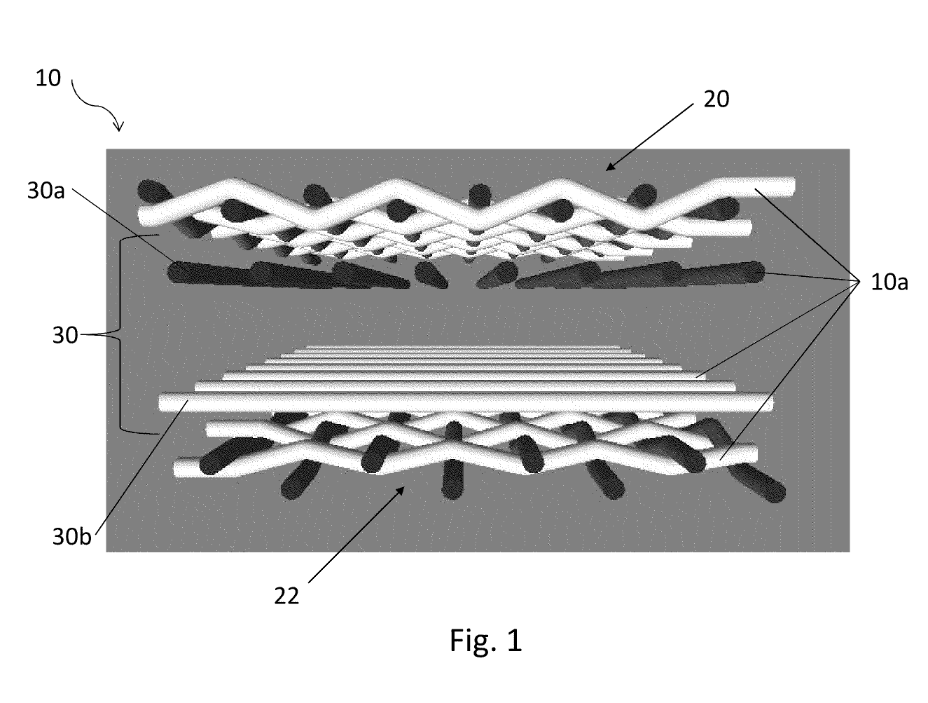

FIG. 1 is a schematic view of a multi-layer composite fabric 10 according to an embodiment of the present disclosure. The multi-layer composite fabric 10 can include a first woven layer 20, a second woven layer 22, and a third non-crimp layer 30. The first woven layer 20 and the second woven layer 22 are depicted as plain weaves, however other types of weave patterns may be used. The layers 10, 20, and/or 30 may be woven together to form a composite fabric 10 as described below. For example, the first woven layer 20 can be woven to the second woven layer 22 and/or at least a portion of the third non-crimp layer 30. However, FIG. 1 shows the layers 10, 20, 30 as not being woven together for ease of illustrating the three layers 10, 20, and 30.

The yarns of the fabric 10 are assembled from a plurality of fibers, for example, multifilament yarns 10a. The first woven layer 20 and the second woven layer 22 may be made of a ballistic fiber. More specifically, the fiber may be a para-aramid, such as, for example, Kevlar® brand fiber. The yarns 10a may be of any linear density, and preferably from approximately 200 denier to 3,000 denier. The third non-crimp layer 30 may also be made of a ballistic material. More specifically, the third non-crimp layer 30 may be made of UHMWPE, such as, for example Spectra® brand fiber manufactured by Honeywell®.

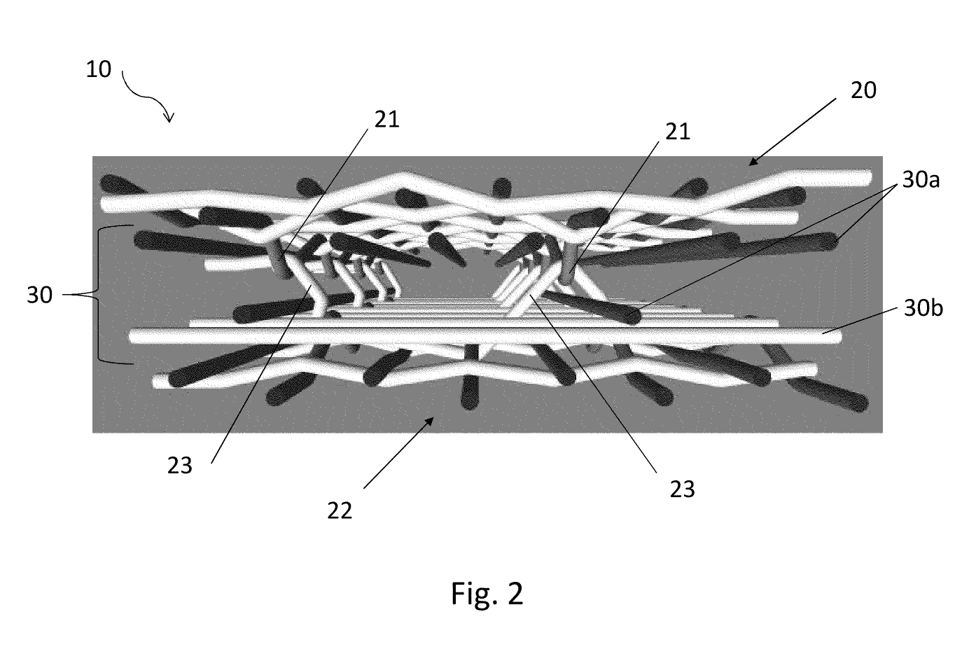

FIG. 2 depicts an exemplary multi-layer composite fabric 10 in woven form. The first woven layer 20 can be woven to the second woven layer 22 from a plurality of warp and weft yarns, with the third non-crimp layer 30 disposed between the first woven layer 20 and the second woven layer 22. In the example shown in FIG. 2, the first layer 20 and the second layer 22 can be joined to each other by picking one or more warp yarns 21 of the first layer using a plurality of weft yarns 23 from the second layer to form the composite fabric. Alternatively, or in addition to the woven structure of FIG. 2, one or more warp yarns of the second layer 22 can be picked to a plurality of weft yarns from the first layer 20 (not shown).

The third layer 30 may be formed by, for example, warp yarns 30a and weft yarns 30b, which are: (1) not woven with one another; and (2) are located between the first layer 20 and the second layer 22 (e.g. in a 0/90 degree conformation). In other embodiments, the third layer 30 may comprise only warp yarns 30a or only weft yarns 30b. By disposing the third non-crimp layer 30 between the first woven layer 20 and second woven layer 22, the third non-crimp layer 30 is stabilized between two woven layers 20, 22. The non-crimp yarns of the third layer 30 can have beneficial effects in the composite fabric 10. For example, the non-crimp yarns may increase the tear strength of the composite fabric compared to a composite fabric made with fully-woven layers. Furthermore, it is possible to exclude resin or other forms of laminate from the multi-layer composite fabric, thereby eliminating weight and stiffness from the fabric associated with resin or laminate.

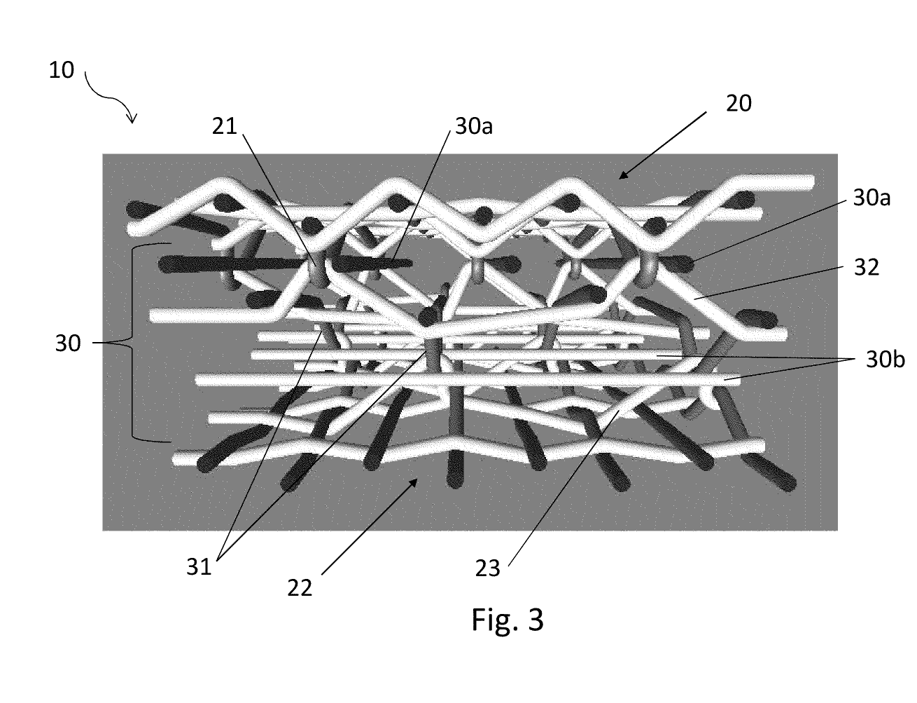

A multi-layer composite fabric 10 can also be made where certain yarns of the third-layer 30 are woven to the first layer 20 and the second layer 22. FIG. 3 shows an example where certain warp yarns 31 of the third layer 30 are picked to weft yarns 23 of the second layer 22, and certain weft yarns 32 of the third layer 30 are picked to warp yarns 21 of the first layer 20. In this embodiment, yarns 31, 32 of the third layer are no longer considered to be “non-crimp” because they are woven to yarns in the first layer 20 and second layer 22. While the woven yarns 31, 32 of the third layer 30 are not “true” non-crimp yarns (like yarns 30a, 30b), the yarns 31, 32 can have a lower crimp than other woven yarns in the composite fabric 10, for example, the yarns of the first woven layer 20 and/or the second woven layer 22. However, other yarns 30a, 30b of the third layer 30 remain non-crimp. Thus, the third layer 30 can include both woven and non-crimped yarns.

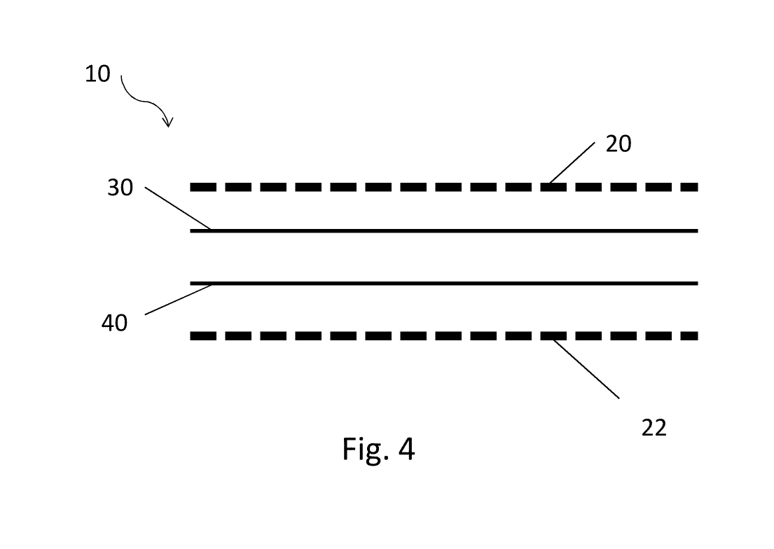

The multi-layer composite fabric 10 may also include one or more additional non-crimp layers, in addition to the third layer 30, disposed between the first woven layer 20 and the second woven layer 22. For example, FIG. 4 shows an additional non-crimp fourth layer 40 included between the first woven layer 20 and the second woven layer 22. The fourth non-crimp layer 40 can also be made of the same material as the third non-crimp layer 30. The fourth non-crimp layer 40 may be disposed at an angle, for example a right angle, relative to the third non-crimp layer 30. Disposing a fourth non-crimp layer 40 at an angle, for example a right angle, relative to the third non-crimp 30 can increase the ballistic properties of the multi-layer composite fabric. The multi-layer composite fabric 10 having four or more layers may be generally joined as described herein.

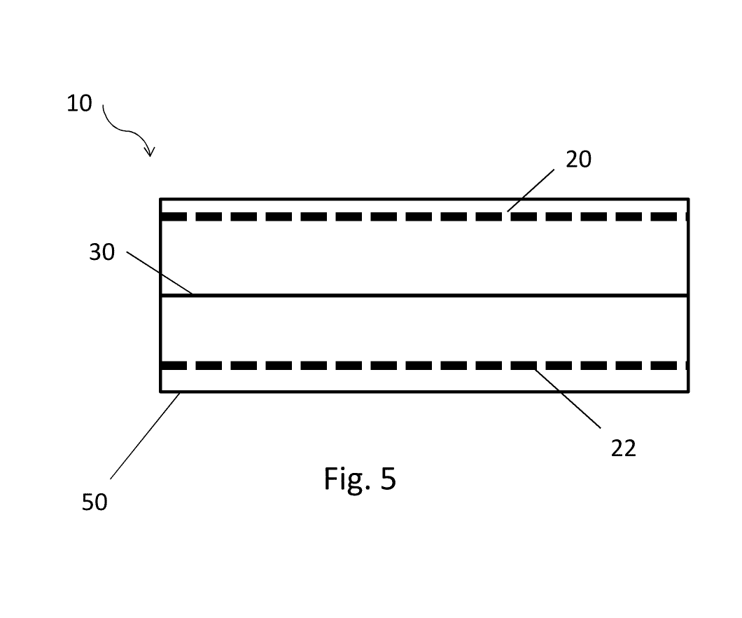

FIG. 5 depicts an example of a multi-layer composite fabric 10 being laminated with a resin or laminate 50. Although it may be advantageous to not use resin or laminate 50 with the multi-layer composite fabric 10, in some embodiments, the fabric 10 can be laminated to increase stiffness and further decrease layer counts. The fabric 10 may also be stitched and edge taped (not shown) depending on the application. The fabrics 10 can be designed using nearly any denier of yarn to achieve a desired fabric weight and properties.

Composite materials of the present disclosure may be used to manufacture garments according to another embodiment of the present disclosure. The garments may be, for example, vests, jackets, pads, braces, etc. The materials may also be used to enhance objects such as cars, briefcases, backpacks, etc. Applications also exist outside of the ballistics fields, including, but not limited to, aircraft, marine, automobile, manufacturing, and construction.

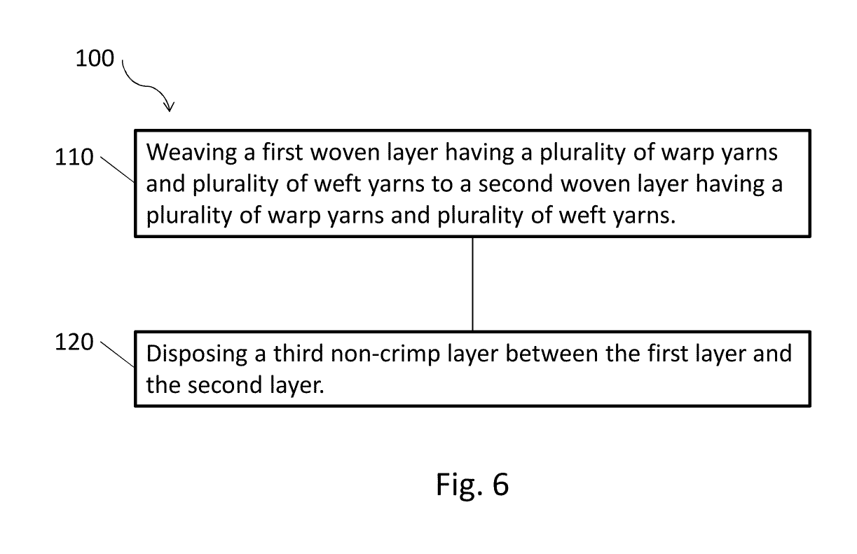

In another embodiment, shown in FIG. 6, the present disclosure is embodied as a method 100 of making a multi-layer composite fabric including weaving 110 a first woven layer having a plurality of warp yarns and plurality of weft yarns to a second woven layer having a plurality of warp yarns and plurality of weft yarns, and disposing 120 a third non-crimp layer between the first layer and the second layer. The first layer and the second layer can be joined to each other by picking one or more warp yarns of the second layer using a plurality of weft yarns from the first layer and/or picking one or more warp yarns of the first layer using a plurality of weft yarns from the second layer to form the composite fabric. The multi-layer composite fabric may or may not include a laminate.

The non-crimp layer(s) can be joined to the first layer and/or the second layer by picking one or more yarns from the first layer and/or second layer. This can assist in keeping the non-crimp layer(s) in place. For example, one stitch per inch can be used along a non-crimp layer to join the non-crimp layer to the first layer and/or the second layer. In another example, more than one stitch per inch can be used along a non-crimp layer to join the non-crimp layer to the first layer and/or the second layer, but not increasing the crimp level of the non-crimp layer to that of a fully woven fabric, such as a sateen. The non-crimp layer(s) can increase the tear strength of the composite fabric compared to a composite fabric made with fully-woven layers.

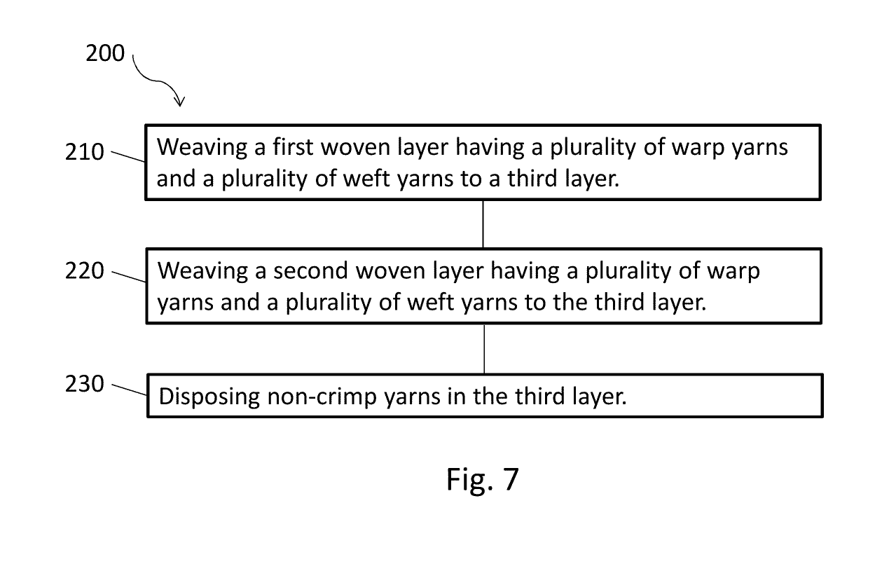

In another embodiment, shown in FIG. 7, the present disclosure is embodied as a method 200 of making a multi-layer composite fabric including weaving 210 a first woven layer having a plurality of warp yarns and a plurality of weft yarns to a third layer, and weaving 220 a second woven layer having a plurality of warp yarns and a plurality of weft yarns to the third layer, and disposing 230 non-crimp yarns in the third layer. The third layer can be located in between the first layer and the second layer. For example, certain warp yarns of the third layer can be picked to weft yarns of the second layer, and certain weft yarns of the third layer can be picked to warp yarns of the first layer. The third layer can include both woven and non-crimp yarns. The woven yarns of the third layer may have a lower crimp than the yarns of the first layer and yarns of the second layer.

For non-ballistic applications, it may be beneficial to apply a resin or laminate to the composite fabrics described herein. In these applications, the rigidity of adding a resin or laminate to the composite fabric may be beneficial. For example, a polyester resin has been shown to be useful for marine applications, and epoxy resin for aircraft applications. By applying the resin to the composite fabric, rather than to individual woven layers, the present disclosure can be lighter and thinner than prior art composite materials.

Although the present disclosure has been described with respect to one or more particular embodiments, it will be understood that these embodiments are intended to be exemplary and that other embodiments of the present disclosure may be made without departing from the spirit and scope of the present disclosure.

We claim:

1. A multi-layer composite fabric, comprising:
a first woven layer having a plurality of warp yarns and plurality of weft yarns;
a second woven layer having a plurality of warp yarns and plurality of weft yarns; and
a third non-crimp layer disposed between the first woven layer and the second woven layer;
wherein the first woven layer is woven to one or more of the following: the second woven layer and at least a portion of the third non-crimp layer.

2. The multi-layer composite fabric of claim 1, wherein the first woven layer and the second woven layer are joined to each other by picking one or more warp yarns of the second woven layer using a plurality of weft yarns from the first woven layer and/or picking one or more warp yarns of the first woven layer using a plurality of weft yarns from the second woven layer to form the composite fabric.

3. The multi-layer composite fabric of claim 1, wherein the third non-crimp layer only includes non-woven yarns.

4. The multi-layer composite fabric of claim 1, wherein the third non-crimp layer includes both woven yarns and non-woven yarns.

5. The multi-layer composite fabric of claim 1, wherein the third non-crimp layer includes non-crimped yarns and woven yarns, the woven yarns of the third non-crimp layer being picked to the first woven layer and/or the second woven layer.

6. The multi-layer composite fabric of claim 5, wherein one or more warp yarns of the third non-crimp layer are picked to the weft yarns of the second woven layer, and one or more weft yarns of the third layer non-crimp layer are picked to the warp yarns of the first woven layer.

7. The multi-layer composite fabric of claim 1, further comprising a fourth non-crimp layer disposed between the first woven layer and the second woven layer.

8. The multi-layer composite fabric of claim 1, wherein the third non-crimp layer includes both woven yarns and non-woven yarns, the woven yarns having a lower crimp than the first woven layer and the second woven layer.

9. The multi-layer composite fabric of claim 7, wherein the third non-crimp is disposed parallel to the fourth non-crimp layer.

10. The multi-layer composite fabric of claim 1, wherein the third non-crimp layer is super-high molecular weight polyethylene.

11. The multi-layer composite fabric of claim 1, wherein the third non-crimp layer is joined to the first woven layer or joined to the second woven layer.

12. The multi-layer composite fabric of claim 1, wherein a resin is added to the composite fabric.

13. The multi-layer composite fabric of claim 1, wherein the composite fabric does not include a resin.

14. The multi-layer composite fabric of claim 1, wherein the composite fabric is made of ballistic fibers.

15. A method of making a multi-layer composite fabric, comprising:
weaving a first woven layer having a plurality of warp yarns and plurality of weft yarns to one or more of the following: a second woven layer having a plurality of warp yarns and plurality of weft yarns and a third non-crimp layer;
wherein the third non-crimp layer is disposed between the first woven layer and the second woven layer.

16. The method of claim 15, wherein the first woven layer and the second woven layer are joined to each other by picking one or more warp yarns of the second woven layer using a plurality of weft yarns from the first woven layer and/or picking one or more warp yarns of the first woven layer using a plurality of weft yarns from the second woven layer to form the composite fabric.

17. The method of claim 16, wherein the third non-crimp layer only includes non-woven yarns.

18. The method of claim 15, wherein the third non-crimp layer includes non-crimped yarns and woven yarns, the woven yarns of the third non-crimp layer being picked to the first woven layer and/or the second woven layer.

19. The method of claim 15, wherein the composite fabric is made of ballistic fibers.

20. The method of claim 15, further comprising applying a resin to the composite fabric.
